(19) United States
(12) Patent Application Publication
(10) Pub. No.: US 2005/0014010 A1
(43) Pub. Date: Jan. 20, 2005

(54) Method to provide wear-resistant coating and related coated articles

(76) Inventors: Timothy Francis Dumm, Westerville, OH (US); Steven W. Webb, Worthington, OH (US)

Correspondence Address: Pepper Hamilton LLP;Firm 21269, 50th Floor,One Mellon Center,, 500 Grant Street, Pittsburgh, PA, 15219, US

(21) Appl. No.: 10/829,555

(22) Filed: Apr. 22, 2004

Related U.S. Application Data
(60) Provisional application No. 60/464,516, filed on Apr. 22, 2003.

(51) Int. Cl. B05D 1/12; B32B 15/04

(52) U.S. Cl. 428/472; 427/180; 427/446; 427/248.1; 428/615; 428/698; 428/627

(57) ABSTRACT

This invention is directed to a coated article having an increased useful lifespan, having a wear-resistant coating comprising a vitreous matrix material and metal coated superabrasive particles distributed therein. The superabrasive particles are coated with a protective metal coating selected from zinc, aluminum, aluminum-silicon alloy, titanium, chromium, nickel, silicon, tin, antimony, copper, iron, stainless steel, silver, alloys thereof, and mixtures thereof. The wear-resistant coating comprising coated superabrasive particles may be applied to the surface of an article by at least one process selected from electroless or electrolytic electroplating process, thermal spraying, and brazing.

### CROSS-REFERENCE TO RELATED APPLICATIONS

This application claims priority to U.S. provisional application Ser. No. 60/464,516, filed Apr. 22, 2003 and entitled “Method To Provide Wear-Resistant Coating and Related Coated Articles”, herein incorporated by reference in its entirety.

### FIELD OF THE INVENTION

The present invention relates to a coated article having a wear-resistant coating and an increased useful lifespan and a method of providing a wear-resistant coating to an article.

### BACKGROUND OF THE INVENTION

There is continued demand from many industries, such as aeronautical, aerospace, automotive, engine components, plant equipment and the like, for applications and components having various desirable characteristics, including corrosion resistance, heat is resistance, wear resistance, and oxidation resistance. Common failure modes for these components typically include changes in dimensional form, development of pits, holes, grooves or other wear patterns that change the uniformity of a surface, and changes in tolerance that leads to inefficiencies in the performance of a component. Coatings of these components may be designed to avoid these common failure modes. Coatings or surface treatments including hard metallic or ceramic coatings, may be applied to component surfaces in order to improve the abrasive and corrosive wear of the base material. The coatings are commonly applied via several methods including thermal sprays, heat treatments for nitriding, carbiding or boriding, PVD and CVD techniques, anodizing and electroplating.

One example of an electroplated coating is a composite coating that comprises an electroless nickel layer having wear resistant particles incorporated within the layer. The particles, which may be either silicon carbide or another superabrasive, are co-deposited as the nickel layer forms onto the base material. The particles impart a more wear resistant characteristic to the nickel layer. U.S. Pat. No. 5,391,407 discloses a process to coat metal surfaces with a diamond-like carbon coating, wherein a Ni/P coating is formed on the uncoated substrate of the article by electroless deposition. In one embodiment, electroless nickel is strengthened with the addition of silicon carbide particles in a nickel/silicon carbide solution.

U.S. Pat. No. 6,156,390 discloses a method to metal plate articles by the co-deposition of fluorinated carbon and diamond material with electroless metal, wherein the diamond material is in the form of synthetic diamonds with an average size in the range of 1 to 5 mm.

Coated diamond superabrasives have been employed in sintered metal bonded or vitreous bonded tools wherein the coatings on the superabrasives aid in tool wear resistance. U.S. Pat. No. 3,779,873 discloses a method to electrolytically metal plate diamond particles. U.S. Pat. No. 5,024,680 discloses the use of a chromium, titanium, or zirconium carbide-forming layer as part of a multi-layer coating on diamond particles. U.S. Pat. No. 5,232,469 discloses multi-layer coated diamond particles wherein at least one of the layer is applied by electroless deposition.

There remains a need to provide methods for metal plating articles that exhibit good wear-resistant properties in the resulting coated article.

### SUMMARY OF THE INVENTION

Surprisingly, it has been found that the use of coated superabrasive particles in a metallic, ceramic or vitreous coating increases the useful lifespan of articles requiring wear-resistant coating, as compared to the use of uncoated superabrasive particles in a wear-resistant coating.

One embodiment of the present invention relates to a coated article comprising a substrate and a wear-resistant coating, wherein the wear-resistant coating comprises a metal, ceramic or vitreous matrix material and superabrasive particles having a protective metallic coating, wherein the coated superabrasive particles are co-deposited within the matrix material. In one embodiment of the present invention, the superabrasive particles are made of diamond, cBN, or mixtures thereof. In one embodiment of the invention, a wear-resistant coating comprises coated superabrasive particles co-deposited within a matrix of nickel, cobalt, iron, chromium, tungsten, molybdenum, carbides, borides, nitrides, oxides, intermettalics, or one or more mixtures thereof. In another embodiment of the invention, the superabrasive particles are coated with a protective metallic coating which may be aluminum, silicon, scandium, titanium, chromium, yttrium, zirconium, niobium, molybdenum, hafnium, tantalum, tungsten, rhenium, the rare earth metals, alloys thereof, or combinations thereof. In another embodiment of the invention, the superabrasive particles may be coated with one or more protective metallic coating layers.

Another embodiment of the present invention relates to a process to form a protective and wear-resistant coating on the surface of an article, comprising the steps of: preparing the surface of the article; and depositing a protective wear-resistant coating on the surface of the article, wherein wear-resistant coating comprises coated superabrasive particles coated with a protective metallic coating layer, with the coated particles co-deposited within a composite coating matrix. In one embodiment of the present invention, the composite coating matrix is a material selected from the group containing nickel, cobalt, iron, chromium, tungsten, molybdenum, carbides, borides, nitrides, oxides, intermettalics, and mixtures thereof. In another embodiment of the invention, the superabrasive particles in a matrix coating are coated with a protective metallic coating which may be aluminum, silicon, scandium, titanium, chromium, yttrium, zirconium, niobium, molybdenum, hafnium, tantalum, tungsten, rhenium, the rare earth metals, and/or combinations thereof. In another embodiment of the present invention, the superabrasive particles are made of diamond, cBN, and/or mixtures thereof.

### BRIEF DESCRIPTION OF THE DRAWINGS

FIG. 1 is a schematic drawing showing one embodiment of the wear-resistant coating of the invention, showing coated diamond particles within a glass matrix.

FIG. 2 is a schematic drawing showing one embodiment of the wear-resistant coating of the invention, showing coated diamond particles within a glass matrix.

FIG. 3 is a schematic drawing showing a prior art coating, wherein uncoated diamond particles are distributed within a glass matrix.

FIG. 4 is a schematic drawing showing a prior art coating, wherein uncoated diamond particles are distributed within a glass matrix.

### DETAILED DESCRIPTION OF THE INVENTION

Before the present compositions and methods are described, it is to be understood that this invention is not limited to the particular processes, compositions, or methodologies described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a”, “an”, and “the” include plural reference unless the context clearly dictates otherwise. Thus, for example, reference to a “article” is a reference to one or more articles and equivalents thereof known to those skilled in the art, and so forth. Unless defined otherwise, all technical and scientific terms used herein have the same meanings as commonly understood by one of ordinary skill in the art. Although any methods and materials similar or equivalent to those described herein can be used in the practice or testing of embodiments of the present invention, the preferred methods, devices, and materials are now described. All publications mentioned herein are incorporated by reference in their entirety. Nothing herein is to be construed as an admission that the invention is not entitled to antedate such disclosure by virtue of prior invention.

In the following description various embodiments of a wear-resistant coated article and a process of providing a wear-resistant coating to an article are provided.

As used herein, a “substrate” is defined as a surface of a part that is exposed to wear. As used herein, a “wear resistant coating” is a layer applied to a substrate for the purpose of providing resistance to abrasive, erosive or, in some cases, chemical wear. Such a coating is a composite comprised of a continuous phase and a particulate phase. The continuous phase can be metal, ceramic or glass. The particulate (discrete) phase is comprised of particles that are usually harder than the continuous phase. As used herein, a “protective coating” is a thin coating that is applied directly to the particles in the discrete phase of the composite. This thin coating is intended to provide a mechanism for improving the bonding between the particle and the continuous phase. As used herein, a “superabrasive” refers to diamond (both natural and synthetic) materials, cubic boron nitride (cBN), and mixtures of diamond and cBN.

One embodiment of the invention relates to a wear resistant coating having improved lifespan in service due to increased particulate retention within the continuous phase.

In one embodiment of the present invention, articles are coated with a wear and corrosion resistant coating, wherein the wear-resistant coating comprises a matrix material and superabrasive particles having a protective metallic coating, wherein the coated superabrasive particles are co-deposited within the matrix material. In another embodiment, the superabrasive particles are coated with a thin layer or layers of a protective metal or metal alloy. The superabrasive particles may be selected from the group consisting of diamond, cBN, and mixtures thereof. The superabrasive particles may be coated with a thin layer of titanium, titanium alloy, chrome, chrome alloy, or mixtures thereof.

The matrix is a metal, ceramic or vitreous matrix. The matrix material may be selected from the group consisting of nickel, cobalt, iron, chromium, tungsten, molybdenum, carbides, borides, nitrides, oxides, intermettalics, and mixtures thereof.

Base Substrate of the Article to be Coated. The coated articles may be made of a variety of materials, and such materials are used as the substrate of the present invention. Suitable substrate materials include but are not limited to metals, metal alloys, organic resins, metal-based materials, polymeric materials, and any other suitable substrate material. The shape and size of the substrate may vary widely. The type of substrate can vary widely, but in one embodiment it is in the form of an engine part, such as a turbine nozzle, a turbine engine component, or a similar engine component.

The term “metal-based” in reference to substrates disclosed herein refers to those which are primarily formed of metal or metal alloys, but which may also include some non-metallic components, e.g., ceramics, intermetallic phases, or intermediate phases. The substrate may also be a heat-resistant alloy, such as a superalloy, which typically has an operating temperature of up to about 1000-1150° C. The term “superalloy” is usually intended to embrace iron cobalt- or nickel-based alloys, which include one or more other elements such as aluminum, tungsten, molybdenum, titanium, and iron. Superalloys are described in various references, such as U.S. Pat. Nos. 5,399,313 and 4,116,723, herein incorporated by reference. High temperature alloys are also generally described in Kirk-Othmer's Encyclopedia of Chemical Technology, 3rd Edition, Vol. 12, pp. 417-479 (1980), and Vol. 15, pp. 787-800 (1981).

The Wear-Resistant Coating of the Present Invention. One embodiment of the present invention includes an improved coating, which is deposited onto the substrate or the article to be coated. The coating provides the substrate with an outer, wear-resistant surface that protects the substrate and increases the longevity of the coated article. A wear-resistant coating comprises a continuous phase and a particulate phase.

Depending on the coating process, the substrate to be coated, the end-use operating conditions/applications of the article, in one embodiment a wear-resistant coating layer is deposited onto the substrate as a monolithic coating having a thickness of about 0.1 to about 10 mils (or about 250 μm). In a second embodiment, the coating has a thickness from about 20 to 50 μm. In other embodiments, multiple layers of the wear-resistant coating are applied onto the substrate. In some embodiments, the wear-resistant coating is deposited onto another over-coating layer already on top of the substrate.

The wear-resistant coating may comprise diamond particles, as used herein, “superabrasive” particles. The superabrasive particles may be hard, sintered bodies of diamond, cubic boron nitride or mixtures thereof and may be processed in any suitable manner. These superabrasive particles are coated with a metallic coating of zinc, aluminum, aluminum-silicon, chromium, titanium, nickel, silicon, tin, antimony, copper, iron (including stainless steel), silver or mixtures of these metals. The coated superabrasive particles within a matrix thus forms the wear-resistant coating compositions.

The superabrasive particles in the composite wear-resistant coating have a metal or metal alloy coating bonded to the surface of the superabrasive particle. In one embodiment of the invention, the coated superabrasive particles are less than about 50 μm in size. In another embodiment, the coated superabrasive particles comprise about 5 to 80% by volume of the applied wear-resistant coating. In yet another embodiment of the invention, the superabrasive particles have little or no significant agglomerations within the composite wear-resistant coating.

In one embodiment, the protective coating layer for the superabrasive particles is formed from a refractory material having the formula MCₓN_{y}, wherein M is a metal, C is carbon having a first stoichiometric coefficient x, and N is nitrogen having a second stoichiometric coefficient y, and wherein 0≦x and y≦2. M is a metal and may be selected from the group of consisting of titanium, chromium, zirconium, hafnium, vanadium, rhenium, ruthenium, osmium, niobium, tantalum, chromium, molybdenum, tungsten, aluminum, and alloys thereof. In another embodiment, the superabrasive particles are coated with a thin layer of titanium or titanium/chrome alloy, which chemically bonds with diamond superabrasive particles forming either TiC or CrC at the particle interface. In another embodiment, the cBN superabrasive particles are coated with titanium or titanium/chrome alloy, and have a chemically bonded coating of TiN or CrN on the superabrasive particle surface.

The metallic coating may be applied onto the surface of the superabrasive particles as one single coating layer or as multiple layers. The metallic coating may be applied via any known process including chemical vapor deposition (CVD), physical vapor deposition (PVD), sputtering, brazing, electroplating salt deposition, and the like.

Coated superabrasive particles and methods for coating such particles are disclosed for example, in U.S. Pat. No. 5,062,865 (assigned to Norton Company), U.S. Pat. No. 6,319,608 (assigned to Diamond Innovations, Inc.); U.S. Pat. No. 6,540,800 (assigned to Powdermets), U.S. Pat. No. 6,372,346 (assigned to EnDurAloy, Inc.), each herein incorporated by reference. In one embodiment, the particles are coated with a uniformly thick and complete coating that is chemically-bonded and/or metallurgically bonded to the superabrasive particles, and not simply bound by mechanical or adhesion bonding. Any suitable metallic coated superabrasive particles are useful in the wear-resistant coating embodiments of the present invention.

A wear-resistant coating according to several embodiments of the present invention may be electroplated, thermosprayed, or brazed onto the substrate. The wear-resistant coating layer may further comprise other particulate matters as described below.

Processes to apply Wear Resistant Coating. The wear-resistant coating may be formed by first preparing the surface of the substrate that receives the coating. The surface may be prepared to provide good adhesion to the wear-resistant coating. In one embodiment, the surface is textured to provide mechanical interlock with the coating. In another embodiment, the substrate surface is prepared by a variety of techniques such as grit blasting and chemical methods. Such preparation of the substrate are known in the art.

Wear-resistant Coating—Electroplating Application: “Electroplating” or “electroless plating” or “electroless deposition” or “electrolytic deposition” as commonly known in the art, and as used herein refers to the metallic deposition (from a suitable bath) of metals, and/or alloys of nickel, cobalt, copper, gold, palladium, iron, and other transition metals, and mixtures thereof, onto a surface to be coated. Electroplating is a suitable means of depositing the wear-resistant coating with coated superabrasive particles according to several embodiments of the present invention.

In one embodiment of the invention, wherein the wear-resistant coating is to be electroplated via an electroless or electrolytic coating process, the wear-resistant coating layer further comprises finely divided particulate matter that are generally insoluble or sparingly soluble within the coating composition. These insoluble particulate materials may be selected from a wide variety of distinct matter having sizes in the range of about 0.1 to about 150 μm, and may be ceramics, glass, talcum, plastics, graphite, oxides, suicides, carbonate, carbides, sulfides, phosphate, boride, silicates, oxylates, nitrides, fluorides of various metals, as well as metal or alloys of boron, tantalum, stainless steel, chromium, molybdenum, vanadium, zirconium, titanium, tungsten, or mixtures thereof. These materials are generally inert with respect to the electroless plating chemistry. In one embodiment, the finely divided particulates are in the size range of 0.5 to 50 μm.

Wear-resistant Coating—Brazing or Spraying Applications. In embodiments wherein the wear-resistant coating is applied onto the substrate via brazing or spraying applications, the coating composition to be applied to the substrate is a coating powder comprising coated diamond particles and other metal components, such as nickel, chromium, molybdenum or cobalt, or with a combination of any of these metals. The coating powder may further comprise other wear resistant components including chromium carbide or Group 5a carbides of vanadium, niobium, or tantalum, hafnium carbide (HfC), zirconium carbide (ZrC), manganese carbide (MnC), iron carbide (FeC), nickel carbide (NiC), cobalt carbide (CoC), silicon carbide (SiC), tungsten carbide (WC), molybdenum carbide (MoC), titanium carbide (TiC), and boron carbide (BC) or mixtures of any of these carbides.

In one embodiment wherein the wear-resistant coating is to be applied in a thermal spray application, the coating composition comprises agglomerates having a size range of from about 5 to about 100 microns, of coated superabrasive particles and ultrafine particles selected from the group consisting of zirconia, tantalum oxide, boron carbide, silicon carbide, titanium carbide, and combinations thereof.

In embodiments wherein the substrate surface is irregular, or contains pits or crevices, the wear-resistant coating may be applied in the form of a braze slurry to fill such regions. Braze slurry coating compositions may further comprise a binder, and optionally, a solvent. A variety of binder materials may be used, e.g., water-based organic materials such as polyethylene oxide and various acrylics, or solvent-based binders. Conventional details related to the mixing of the slurry are described in various references, such as U.S. Pat. No. 4,325,754 herein incorporated by reference. A wear-resistant coating may be applied to a substrate by any of those suitable slurry methods.

In an application wherein the wear-resistant coating is to be applied onto a substrate in a brazing process, the wear-resistant coating may be first applied in the form of a metal foil. The wear-resistant coating foil can be made by a variety of techniques. For example, wear coating powder comprising coated superabrasive particles and other components as described above, is deposited onto a removable support sheet such as a thin layer of metal about 25 microns to about 1300 microns. The removable support sheet may be pre-processed, such as by surface finishing, (e.g., grinding), and preferably, have a thickness of about 100 microns to about 750 microns. In one embodiment, the support sheet is actually a removable substrate, such as a replica or duplicate of the “final substrate” requiring the wear-resistant coating of the invention. A wear-resistant foil formed may be subsequently brazed onto a final substrate.

A thermal spray technique may be employed for the deposition of the wear coating powder onto the support sheet to form a foil. Examples include vacuum plasma spray (VPS), high velocity oxygen fuel (HVOF), or air plasma spray (APS). Other deposition techniques could be used as well, such as sputtering, physical vapor deposition (PVD) or electron beam physical vapor deposition (EBPVD). HVOF is a continuous combustion process in which a powder is injected into a jet stream of a spray gun at very high speeds. Those of ordinary skill in the art are familiar with various HVOF details, such as the selection of primary gasses, secondary gasses (if used), and cooling gasses, gas flow rates, power levels, coating particle size, and the like. As another illustration, plasma spray techniques are also known in the art and described, for example, in the Kirk-Othmer Encyclopedia of Chemical Technology, 3rd Edition, Vol. 15, page 255, and references noted therein. In general, the typical plasma spray techniques involve the formation of high-temperature plasma, which produces a thermal plume. The wear-resistant coating material of the invention, in the form of a powder, is fed into the plume. The powder particles melt or are heated to a high temperature in the plasma and are accelerated toward the substrate being coated. If the process is carried out in an air environment, it is often referred to as APS. Information regarding the other deposition techniques (e.g., vacuum plasma deposition, sputtering, PVD, and the like) is also readily available. Those of skill in the art will be able to select particular operating conditions for using each of these techniques to deposit a foil of the wear-resistant coating material comprising coated diamond particles on the support sheet.

The wear-resistant metal foil is subsequently detached from the support sheet using known techniques in the art. In one embodiment, a release coating can be applied to the removable support sheet prior to application of the wear coating material. Suitable release coatings are known in the art. In another embodiment, an etchable coating such as aluminum may be applied to the removable support sheet prior to application of the wear coating material. After the wear coating material is applied, the coated support sheet may be treated in a bath of a solution which selectively etches the aluminum, such as aqueous potassium hydroxide. Removal of the aluminum layer results in detachment of the foil from the removable support sheet.

Electroplating Process. Electroless (autocatalytic) coating processes are generally known in the art and are suitable coating processes for several methods of the present invention. In one embodiment, the electroless coating process is as disclosed in U.S. Pat. No. 5,145,517. Electrolytic coating processes are also suitable coating techniques and are described in U.S. Pat. No. 6,355,154.

In one embodiment of the invention, a standard electroless electroplating process is used to apply the wear-resistant coating onto the article to be coated, with a standard electroless metal-plating bath. In an embodiment, electroplating is performed with a coating comprising superabrasive particles within a nickel metallic matrix. The particulate matters including the coated superabrasive particles are dispersed within a nickel-plating bath using chemical surfactants. When the reducing agent is added, the nickel ions precipitate out and plate onto the surface to be coated. In the process of precipitating out of solution, the nickel ions create a driving force that captures suspended particles near the surface thereby entrapping these within the forming nickel layer. The particles are co-deposited within the nickel and a uniform coating of coated diamond particles in a nickel matrix.

In one embodiment, wherein metal coated superabrasive particles are used in the wear-resistant coating composition of the invention, it is found that the vitreous matrix materials in the coating composition form a stronger adhesion to the coated surface as compared to the use of uncoated superabrasive particles. In an embodiment, titanium coated diamond particles within a vitreous matrix form the wear-resistant coating. The use of the coated superabrasive particles provides an advantage over the prior art coating compositions in that there is increased adhesion between the coated abrasives particles and the matrix material. Rather than being just mechanically held in a loose matrix shell, it is found that the vitreous matrix material such as glass fully envelopes and “wets” the metal-coated superabrasive particles. For example, the interface between the titanium or chromium of the protective coating and matrix material may be a metallic chemical bond. Thus long-lasting and wear-resistant, the coating of the present embodiments is advantageous over uncoated superabrasives.

Brazing Processes. Besides electroplating, the wear-resistant coating may also be applied onto the substrate to be coated via brazing processes. The coating may be in the form of a foil, a powder (as previously described), a paste or putty, or as a tape. Suitable brazing or fusing processes are similar to any conventional brazing operation known in the art. One exemplary reference for details regarding brazing or fusing is the text entitled “Modern Metalworking,” ed. J. R. Walker, The Goodhear-Willcox Co., Inc. 1965, pp. 29-1 to 30-24 herein incorporated reference in its entirety.

Upon heating the braze mixture in either a furnace or by direct flame, the braze alloy melts and the metal and particles spread to a uniform thickness. In one embodiment, the wear-resistant braze is melted and thereby bond to metal surfaces at a temperature ranging from about 500° C. to about 1700° C. At these temperatures, the uncoated superabrasives would experience significant thermal degradation, i.e., begin to graphitize or oxidize. Applicants have found that the metal coating, e.g., a titanium or chromium coating on the superabrasive particles provide a surprisingly protective barrier from the heat and oxidative environment that exists when the braze alloys are heated. In addition to the protection from thermal degradation, it is also found that in some embodiments, the metal coating layer on the superabrasive particles also forms extremely strong bonds with the braze metals, thereby forming a composite in which the superabrasive particles are firmly retained by the matrix material. While not wishing to be bound by theory, the bonding observed between the coated superabrasive particles and the matrix material is believed to be chemical. By contrast, only mechanical or adhesion bonding has been observed between uncoated superabrasive particles in a vitreous matrix.

If the wear-resistant coating is to be applied in the form of a foil, a braze tape can be used to attach the coating foil onto the substrate. Such tapes are well known in the art, and are commercially available, such as the Amdry™ line of tapes from Sulzer-METCO, Inc. Suitable tapes may be obtained with an adhesive on one or both sides, so that the tape may be initially attached to either the substrate or the wear-resistant coating foil.

In one embodiment of the present invention, wherein the wear-resistant coating is applied in the form of a braze slurry, the spray slurry containing the coated superabrasive particles may be sprayed, painted, or tape-cast onto the substrate to be coated with the wear-resistant coating. Alternatively, the braze slurry composition may be applied to the surface region of the foil which will contact the desired region of the substrate. In one embodiment, the braze slurry composition could be applied to both the wear coating foil and the substrate region which will be in contact with the foil.

In embodiments wherein the wear-resistant coating of the present invention is to be applied onto a substrate which does not lend itself to the use of a furnace, e.g., when the component itself is too large to be inserted into a furnace, a torch or other localized heating means may be used. For example, a torch with an argon cover shield or flux may be directed at the brazing surface. Specific, illustrative types of heating techniques for this purpose include the use of gas welding torches (e.g., oxy-acetylene, oxy-hydrogen, air-acetylene, air-hydrogen), RF welding, TIG (tungsten inert-gas) welding, electron-beam welding, resistance welding, and the use of IR lamps.

It should be noted that when an article having a pre-existing wear coating becomes worn or damaged, it may be carefully repaired with one of the wear-resistant coating and methods of the present invention to prevent erosion of the underlying substrate. Furthermore, it is also possible, as with a turbine engine component, to repair the coating while the turbine is in service, i.e., after its delivery from the manufacturing site.

Thermal Spray Processes. In another suitable coating technique of the present invention, thermal spray processes involve entraining and mixing metallic or ceramic powders together in a high-velocity airstream. The particles in the airstream are then directed through a nozzle from which also exists a high temperature, high velocity flame. When the flame and particle airstream impact on the surface to be coated the semi-molten particles impinge on the heated substrate and quickly cool and stick to it. Depending on the dwell time and particle concentration in the airstream, the particle layer builds up to the thickness desired. Common and suitable types of thermal spray processes are HVOF (High Velocity Oxygen Fuel), Plasma Spray and LVOF. For example, a suitable thermal spray process for applying a coating onto a substrate is described in European Patent Serial No. EP0536355B1 herein incorporate by reference in its entirety.

Superabrasive particles coated with a protective metal coating such as titanium or chromium in a fine-sized powder may be mixed with fine powders of the thermal spray metal or ceramic matrix powders. The coated superabrasive particles may be co-deposited with the metal or ceramic particles onto the substrate to form a coating layer of superabrasive particles in a metal or ceramic matrix. The temperatures involved in the thermal spray process can range from about 1500° C. to about 10,000° C. At these temperatures, a bare, uncoated superabrasive particle would oxidize very rapidly even in a very short time. By contrast, a metal coating, e.g., the titanium or chromium coatings on the superabrasive particles, help to protect the superabrasive particles in this extremely high temperature environment. While not wishing to be bound by theory, the metal coating on the superabrasive particles surprisingly provide a much stronger bond to the surrounding matrix material and therefore result in a more durable wear resistant surface.

Whether the coating process is electroplating, thermal spraying, or brazing, it has been found that when a wear-resistant coating with metal coated superabrasive particles such as Ti- or Cr-coated superabrasive particles is applied onto articles which are often subjected to abrasive forces, there are fewer particle pullouts because wear-resistant particles are more tightly bound within the coating. The net result of having fewer particle pullouts is that the coating of the present invention is more wear resistant and lasts longer than coatings with uncoated superabrasive particles. As previously indicated, with a tighter adhesion of superabrasive particles within the vitreous matrix, e.g., between a nickel metal matrix and the protective metal coating of Ti or Cr at the interfaces of coated superabrasives, there are fewer pathways of corrosive liquids to penetrate into the coating, for a more corrosion resistant surface.

### EXAMPLE 1

### Comparison Between Coatings With Coated Diamond Particles and Uncoated Diamond Particles

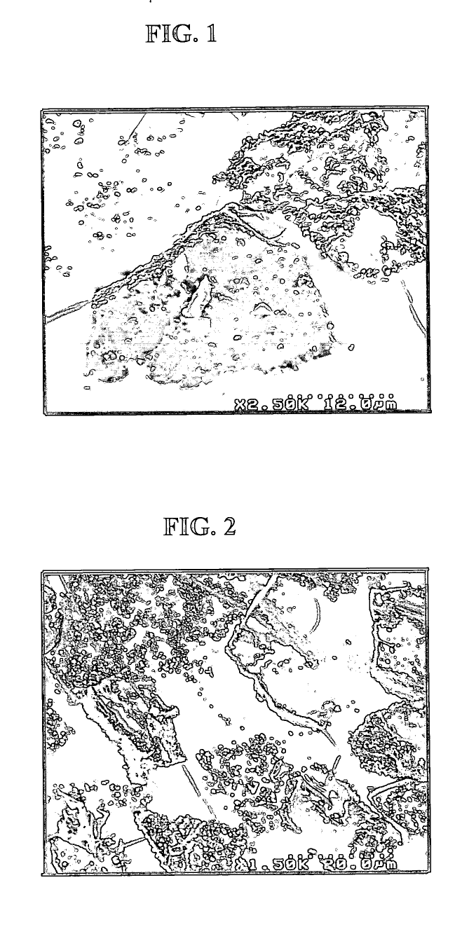

As seen in FIGS. 1-4, a coating embodiment of the present invention wherein titanium-coated diamond particles are distributed within a glass matrix is compared to prior art coatings wherein uncoated diamond particles are contained within a glass matrix. FIGS. 1 and 2 represent a wear-resistant coating embodiment of the present invention wherein diamond particles of about 30 μm to about 40 μm are coated with titanium and deposited within a glass matrix material to form a wear-resistant coating. As illustrated by FIGS. 1 and 2, the glass matrix “wets” the surface of the coated diamond particles, as illustrated by the “textured” appearance of the coated particles within the glass matrix. This wetting in FIGS. 1 and 2 leads to better diamond particle adhesion and retention within the matrix. Thus an improved wear-resistant coating comprising coated diamond particles within a matrix material may be provided for various applications.

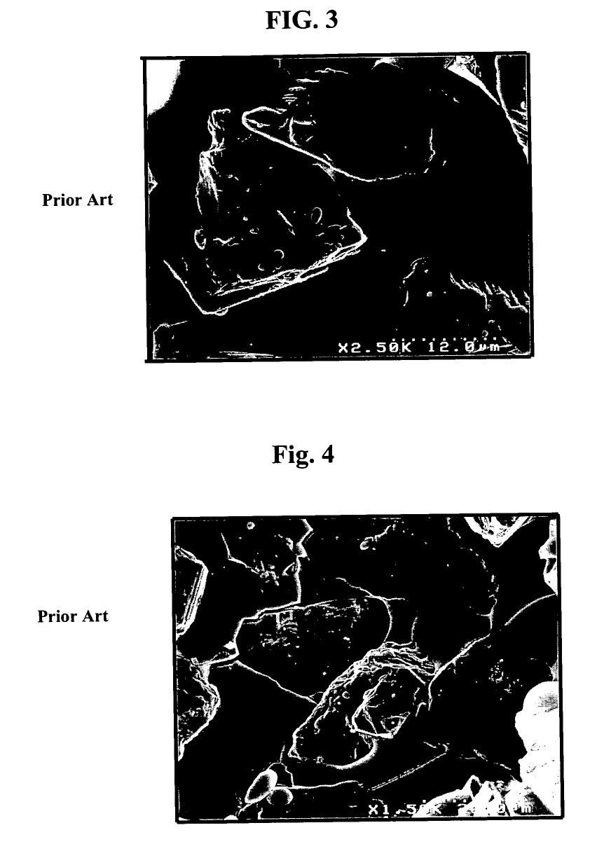

By contrast, FIGS. 3 and 4 are the comparison figures to FIGS. 1 and 2 respectively. FIGS. 3 and 4 represent prior art coatings wherein uncoated diamond particles are distributed into a glass matrix to form a coating. The particles are held into the glass matrix by mechanical adhesion alone, the glass does not appear to wet the surface of the diamond particles. Thus, the uncoated diamond particles are subject to more “pullout” than the coated diamond particles illustrated in FIGS. 1 and 2. In fact, gaps or air pockets between the surface of the uncoated diamond particles and the glass matrix material may be observed in FIGS. 3 and 4.

What has been described and illustrated herein are embodiments of the invention along with some of their variations. The terms, descriptions and figures used herein are set forth by way of illustration only and are not meant as limitations. Those skilled in the art will recognize that many variations are possible within the spirit and scope of the invention, which is intended to be defined by the following claims and their equivalents in which all terms are meant in their broadest reasonable sense unless otherwise indicated.

1. A coated article comprising a substrate and a wear-resistant coating, wherein the wear-resistant coating comprises a metal, ceramic or vitreous matrix material and superabrasive particles having a protective metallic coating, wherein the coated superabrasive particles are co-deposited within the matrix material.

2. The coated article of claim 1, wherein the matrix material is selected from the group consisting of nickel, cobalt, iron, chromium, tungsten, molybdenum, carbides, borides, nitrides, oxides, intermetallics, and mixtures thereof.

3. The coated article of claim 1 wherein the superabrasive particles are made of cubic boron nitride, diamond or a mixture thereof.

4. The coated article of claim 1, wherein the protective metallic coating is a metal selected from the group consisting of aluminum, silicon, scandium, titanium, vanadium, chromium, yttrium, zirconium, niobium, molybdenum, hafnium, tantalum, tungsten, rhenium, Xs the rare earth metals, and a mixture thereof.

5. The coated article of claim 1, wherein the substrate comprises a material selected from the group consisting of metals, metal alloys, organic resins, metal-based materials, polymeric materials and mixtures thereof.

6. The coated article of claim 1, wherein the substrate comprises an organic resin containing a reinforcing component.

7. The coated article of claim 1, wherein the wear-resistant coating is applied onto said substrate in the form of a powder, slurry, paste, tape, or foil.

8. The coated article of claim 1, wherein the wear-resistant coating composition is applied to the substrate by a process selected from the group consisting of thermal sprays, heat treatments, PVD techniques, CVD techniques, anodizing, electroplating, HVOF, and brazing.

9. The coated article of claim 1, wherein the coated superabrasive particles are less than about 50 μm in size.

10. The coated article of claim 1, wherein the protective metallic coating is a refractory material having the formula MCₓN_{y}, wherein M is a metal, C is carbon having a first stoichiometric coefficient x, and N is nitrogen having a second stoichiometric coefficient y, and wherein 0≦x and y≦2.

11. The coated article of claim 1, wherein the wear-resistant coating further comprises finely divided insoluble or sparingly soluble particulate matter.

12. The coated article of claim 1, wherein the wear-resistant coating has a thickness of up to about 1000 μm.

13. The coated article of claim 1, wherein the protective coating chemically bonds to the superabrasive particles.

14. The coated article of claim 1, wherein the protective coating chemically bonds to the metal, ceramic or vitreous matrix material.

15. The coated article of claim 1, wherein the coated superabrasive particles are distributed uniformly within the wear-resistant coating.

16. A method of providing a wear-resistant coating to a substrate comprising:
preparing a surface of the substrate; and
depositing a protective wear-resistant coating onto the surface of the substrate, wherein the wear-resistant coating comprises superabrasive particles having a protective metallic coating and wherein the coated superabrasive particles are co-deposited onto the substrate within a metal, ceramic, or vitreous matrix material.

17. The method of claim 16, wherein the matrix material is selected from the group consisting of nickel, cobalt, iron, chromium, tungsten, molybdenum, carbides, borides, nitrides, oxides, intermetallics, and mixtures thereof.

18. The method of claim 16, wherein the preparation step comprises texturing the surface of the substrate.

19. The method of claim 16, wherein the wear-resistant coating is deposited at a process temperature above about 500° F.

20. The method of claim 16, wherein the wear-resistant coating is deposited using a process selected from the group consisting of thermal sprays, heat treatments, PVD techniques, CVD techniques, anodizing, electroplating, HVOF, and brazing.

21. The method of claim 16, wherein the superabrasive particles are made of cubic boron nitride, diamond or a mixture thereof.

22. The method of claim 16, wherein the protective metallic coating comprises a metal selected from the group consisting of aluminum, silicon, scandium, titanium, vanadium, chromium, yttrium, zirconium, niobium, molybdenum, hafnium, tantalum, tungsten, rhenium, the rare earth metals, and mixtures thereof.

23. The method of claim 16, wherein the substrate comprises a material selected from the group consisting of metals, metal alloys, organic resins, metal-based materials, and polymeric materials and mixtures thereof.

24. The method of claim 16, wherein the wear-resistant coating is applied onto said substrate in the form of a powder, slurry, paste, tape, or foil.

25. The method of claim 16, wherein the protective metallic coating is a refractory material having the formula MCₓN_{y}, wherein M is a metal, C is carbon having a first stoichiometric coefficient x, and N is nitrogen having a second stoichiometric coefficient y, and wherein 0≦x and y≦2.

26. The method of claim 16, wherein the protective coating chemically bonds to the superabrasive particles.

27. The method of claim 16, wherein the protective coating chemically bonds to the matrix material.

28. The method of claim 16, wherein the coated superabrasive particles are distributed uniformly within the wear-resistant coating.
